(19) United States
(12) Patent Application Publication
(10) Pub. No.: US 2008/0281560 A1
(43) Pub. Date: Nov. 13, 2008

(54) Methods and Systems for Automatic Accommodation of Multiple Measurement Types by Shared Acquisition Hardware

(75) Inventors: Kathryn A. Engholm, Portland, OR (US); Craig D. Bryant, Portland, OR (US); Yi He, Portland, OR (US)

Correspondence Address: MATTHEW D. RABDAU;TEKTRONIX, INC., 14150 S.W. KARL BRAUN DRIVE, P.O. BOX 500 (50-LAW), BEAVERTON, OR, 97077-0001, US

(73) Assignee: TEKTRONIX, INC., Beaverton, OR (US)

(21) Appl. No.: 12/092,566

(22) PCT Filed: Nov. 3, 2006
(86) PCT No.: PCT/US2006/060544

§ 371 Date: May 2, 2008

Related U.S. Application Data
(60) Provisional application No. 60/733,524, filed on Nov. 4, 2005.

(51) Int. Cl. G01N 37/00

(52) U.S. Cl. 702/189

(57) ABSTRACT

Embodiments of the present invention comprise systems and methods for determining measurement apparatus acquisition parameters and related processing.

### RELATED REFERENCES

This application claims the benefit of U.S. Provisional Patent Application No. 60/733,524, entitled “Appropriate Provisional Application,” filed on Nov. 4, 2005.

### FIELD OF THE INVENTION

Embodiments of the present invention comprise methods and systems for automatic determination of measurement device acquisition parameters, which effectuate a device configuration that will accommodate multiple measurement types.

### BACKGROUND

Measurement instruments, such as spectrum analyzers, oscilloscopes and other instruments, have the ability to acquire a data record and analyze it using multiple measurements concurrently. Prior digital measuring instruments were designed to perform one measurement or set of related measurements at a time. With these instruments, a user typically chooses a measurement and sets up its parameters. When multiple measurements are selected, the user is faced with the problem of manually resolving conflicts in the acquisition parameters.

### SUMMARY

Some embodiments of the present invention comprise methods and systems for selecting multiple measurements, determining acquisition parameters that will accommodate some set of the selected measurements, configuring the measurement device with the acquisition parameters and acquiring source data that meets the requirements of the selected measurements with the configured device. In some embodiments, an instrument may automatically configure itself to acquire the data necessary to perform the selected measurements. Some embodiments may comprise only functions for determining acquisition parameters that will accommodate some set of the selected measurements.

The foregoing and other objectives, features, and advantages of the invention will be more readily understood upon consideration of the following detailed description of the invention taken in conjunction with the accompanying drawings.

### BRIEF DESCRIPTION OF THE SEVERAL DRAWINGS

FIG. 1 is a diagram showing an exemplary embodiment of the present invention comprising an acquisition parameter determination module;

FIG. 2 is a diagram showing an exemplary embodiment of the present invention comprising an acquisition parameter determination module and a measurement adaptability module;

FIG. 3 is a diagram showing an exemplary embodiment of the present invention comprising an acquisition parameter determination module and a measurement priority module;

FIG. 4 is a diagram showing an exemplary embodiment of the present invention comprising an acquisition parameter determination module, a measurement adaptability module, a measurement priority module and a processing module;

FIG. 5 is a flow chart showing an exemplary embodiment of the present invention comprising automatic determination of acquisition parameters;

FIG. 6 is a flow chart showing an exemplary embodiment of the present invention comprising automatic determination of acquisition parameters with measurement adaptability data access;

FIG. 7 is a flow chart showing an exemplary embodiment of the present invention comprising automatic determination of acquisition parameters with measurement priority data access;

FIG. 8 is a flow chart showing an exemplary embodiment of the present invention comprising automatic determination of acquisition parameters and source data processing;

FIG. 9 is a flow chart showing an exemplary embodiment of the present invention comprising automatic determination of acquisition parameters, measurement adaptability data access, measurement priority data access and source data processing; and

FIG. 10 is a flow chart showing an exemplary embodiment of the present invention comprising application of priority data.

### DETAILED DESCRIPTION OF EXEMPLARY EMBODIMENTS

Embodiments of the present invention will be best understood by reference to the drawings, wherein like parts are designated by like numerals throughout. The figures listed above are expressly incorporated as part of this detailed description.

It will be readily understood that the components of the present invention, as generally described and illustrated in the figures herein, could be arranged and designed in a wide variety of different configurations. Thus, the following more detailed description of the embodiments of the methods and systems of the present invention is not intended to limit the scope of the invention but it is merely representative of the presently preferred embodiments of the invention.

Elements of embodiments of the present invention may be embodied in hardware, firmware and/or software. While exemplary embodiments revealed herein may only describe one of these forms, it is to be understood that one skilled in the art would be able to effectuate these elements in any of these forms while resting within the scope of the present invention.

Some embodiments of the present invention comprise methods and systems that allow a user to select a plurality or combination of measurements for computation and display. In some embodiments, these measurements may be multiple, unrelated measurements that can be performed using data from a single acquisition hardware system. In some embodiments, measurements may be calculated on the same data set. This may be done to ensure time correlation among the results.

In some embodiments, an instrument may receive or detect the selected measurements' attributes and use this data to select, calculate or otherwise determine acquisition parameters that will accommodate the selected measurements. Acquisition parameters may be determined that will be suitable for as many of the measurements as possible. In some embodiments, acquisition parameters may be selected according to specified measurement adaptability rules and/or measurement priority rules. In some embodiments, a user does not need to set or even be aware of acquisition parameters.

In alternative embodiments a user may set some or all acquisition parameters. When a user sets the acquisition parameters directly, these embodiments may verify the compatibility of the selected acquisition parameters and alert a user to any incompatibility. In some embodiments, the resulting acquisition data may be processed so as to be made compatible with one or more measurements.

In some embodiments, an instrument may provide correlated results for combinations of measurements. In some of these embodiments, the results may be expressed in multiple domains (e.g., time, frequency, power, phase, etc.).

In some embodiments of the present invention, acquisition parameters that are defined to accommodate multiple measurements may comprise sampling rate, length of acquisition, acquisition frequency range, reference level, signal path gain, attenuation settings, dither settings, number of samples, filtering and correction parameters, input source selection and others.

In some embodiments of the present invention, acquisition parameters may be optimized for a specific measurement or measurements, forcing other measurements to adapt, if possible, to the resulting data. This optimization may be preset as a default value, selected by a user, automatically determined or otherwise set.

In some embodiments, acquisition parameters may be biased towards higher priority measurements. Priority can be set by the user, set automatically, set as a default or otherwise determined.

In some embodiments, acquisition parameters may be determined to allow all measurements, a majority of measurements, or some quantity or level of measurements to produce ideal, good, or acceptable results based upon measurement adaptability or tolerance parameters.

In some embodiments, one, or more, measurement mechanisms may be predetermined, user-selected or automatically determined.

Some embodiments may notify a user regarding suitability of resulting acquisition data for each measurement. In some embodiments, a message, such as “optimized,” “OK,” “compromised” or “not usable,” may be displayed with the measurement data to show how well the acquisition parameters were set to accommodate a particular measurement.

Some embodiments of the present invention comprise adaptability data or information about each measurement's ability to adapt to acquisition data with parameters greater than or less than ideal values. This information may be correlated with each measurement and may be stored in a device such as an adaptability storage or can be managed by some other entity within the measuring system or in communication with the measuring system, including entry by the user.

Some embodiments of the present invention may also comprise digital resampling, filtering, frequency shifting and other digital or non-digital processing on the acquisition data to produce alternate forms of the acquisition record, each suited to a particular measurement or combination of measurements. These functions may be performed by a processing module. These new data records may have their parameters (such as sampling rate, record length, frequency range, level, etc.) matched to values required by the various measurements.

In an exemplary embodiment of the present invention, multiple measurements with conflicting acquisition length requirements may be accommodated. In this situation, acquisition settings are found that allow both measurements to produce optimum results. In this example, measurement A is a spectrum trace, which requires 80 μsec of sample data in order to achieve its selected Resolution Bandwidth (RBW) setting. Measurement B is a pulse rate calculation, which requires 1 msec of sample data in order to cover an entire pulse period.

In these embodiments, the accommodation logic is notified or otherwise becomes informed of these two demands upon acquisition length. These embodiments may then determine that a solution is to set the acquisition length to 1 msec, because these embodiments have access to information that Measurement A can handle excess acquisition length and that Measurement B cannot be performed with a data record shorter than specified. In this example, 1 msec of sample data is acquired and delivered to both measurements.

In another exemplary embodiment, post-capture processing of the acquisition record is performed to make it suitable for selected measurements. In this example, measurement A is a spectrum trace, which has a Span of 100 MHz. Measurement B is an Error Vector Magnitude (EVM) measurement, which has a Measurement Bandwidth of 35 MHz. In this example, the exemplary embodiment may determine that an acquisition bandwidth of 100 MHz will provide suitable data to both measurements. In this case, an unmodified 100-MHz record may be supplied to the spectrum measurement process. The system of this exemplary embodiment may then digitally filter the acquired record to 35 MHz of bandwidth and supply the filtered (processed) record to the EVM measurement process.

Some embodiments of the present invention may comprise multiple acquisition modules (e.g., acquisition boards) with varying bandwidth, resolution and other capabilities. Some embodiments may comprise a lower-resolution, wider-bandwidth acquisition module and a higher-resolution, narrower-bandwidth acquisition module. When one measurement requires the higher-bandwidth acquisition module and one measurement requires the higher-resolution acquisition module, both measurements may be accommodated by acquiring multiple data records with the higher-resolution, narrower-bandwidth acquisition module. For example, when a first measurement requires a 40 MHz bandwidth at a high resolution and a second measurement requires a 160 MHz bandwidth (at a lower resolution) and the high-resolution acquisition module is restricted to a 40 MHz-wide bandwidth, both measurements may be accommodated by determining acquisition parameters that configure an acquisition module to acquire multiple data records with 40 MHz-wide bandwidths (e.g., 0-40 MHz, 40-80 MHz, 80-120 MHz and 120-160 MHz). These spectral traces computed from these records may then be “stitched” together to form a 160 MHz-wide results trace. In some cases, the acquired data may need to be filtered or otherwise processed to meet the requirements of one or both of the measurements.

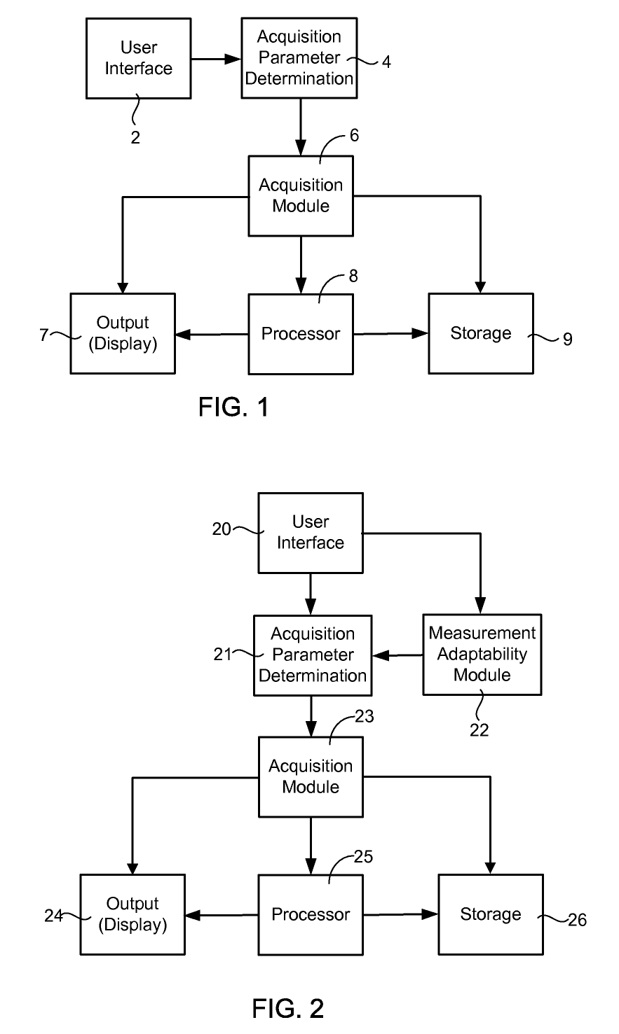

Elements of embodiments of the present invention may be embodied in hardware components, firmware components or code, software code or other computer-readable instructions. Some embodiments of the present invention may be described with reference to FIG. 1. These embodiments comprise a user interface 2 for receiving user input. A user may input measurement selections into the user interface 2. These measurement selections may comprise measurement definitions and measurement constraint data. Measurement selections, measurement definitions and measurement constraint data may be referred to as measurement configuration data. In some embodiments, a user may also input measurement adaptability data and/or measurement priority data.

These embodiments may also comprise an Acquisition Parameter Determination Module (APDM) 4 for determining acquisition parameters that will accommodate the selected measurements. After the measurements have been selected and any additional user input relative to the measurements has been received, the APDM 4 may determine acquisition parameters that will configure the acquisition module 6 for acquisition of data appropriate for the selected measurements. In some embodiments, including those in which additional constraints are put on the measurements, acquisition parameters may be automatically selected to meet those constraints as well. Once acquisition parameters are selected, they may be sent to the acquisition module (AM) 6 and/or may be otherwise used to configure the AM 6 for acquisition of source data for the selected measurements. When this source data has been collected, the source data may be sent to an output device 7, such as a display. In some embodiments, the source data may be sent to a memory or storage device 9 where it may be stored for future access.

In some embodiments, the source data output from the AM 6 may not be suitable for direct display or storage. In these embodiments, the AM 6 may send the raw source data to a data processor 8 where the source data may be processed to conform to measurement requirements, output or storage constraints or other constraints. In some embodiments, the data processor 8 may perform signal processing tasks such as, but not limited to, filtering, transformation and other processing. When the processing is complete, the outcome is processed source data, which may be sent to a measurement process, to an output device 7, such as a display, to a storage device 9 or to some other destination that may be local or remote to the AM 6.

Some embodiments of the present invention may be described with reference to FIG. 2. These embodiments comprise a user interface (UI) 20, like the UI 2 described in the previous exemplary embodiment. UI 20 may receive user input and transmit that input to an APDM 21. UI 20 may also receive user input relative to measurement adaptability, such as acceptable measurement tolerances and other data, and transmit that data to a measurement adaptability module (MAM) 22, which may comprise data storage (e.g., memory, hard drive, etc.) and may further comprise data access functions (e.g., database, etc.). Input to the MAM 22 may be input at a different time than measurement configuration data and may be stored for use with multiple measurements.

Measurement configuration data may be sent to the APDM 21 where an acquisition parameter may be determined based on the selected measurements and any measurement adaptability data. Measurement adaptability data may be used to determine acceptable measurement tolerances, which can be a factor in determining whether multiple measurements can be performed simultaneously. If selected measurements cannot be performed simultaneously, the APDM 21 may alert a user to the measurement incompatibility or may prompt a user for alternative measurements or measurement adaptability options. If the measurements can be accommodated with a specific set of acquisition parameters, the parameters are set and transmitted to the Acquisition Module (AM) 23 for module configuration.

Acquisition parameters are received at the AM 23 and configuration of the module is performed. Source data may then be acquired with the configured AM 23. When source data has been collected and processed by one or more measurement processes, the measurement data may be sent to an output device 24, such as a display. In some embodiments, the measurement data may be sent to a memory or storage device 26 where it may be stored for future access.

In some embodiments, the source data output from the AM 23 may not be suitable for direct measurement, display or storage. In these embodiments, the AM 23 may send the raw source data to a data processor 25 where the source data may be processed to conform to measurement requirements, output or storage constraints or other constraints. In some embodiments, the data processor 25 may perform signal processing tasks such as, but not limited to, filtering, domain transformation and other processing. When the processing is complete, the processed source data may be sent to a measurement process, to an output device 24, such as a display, to a storage device 26 or to some other destination that may be local or remote to the AM 23.

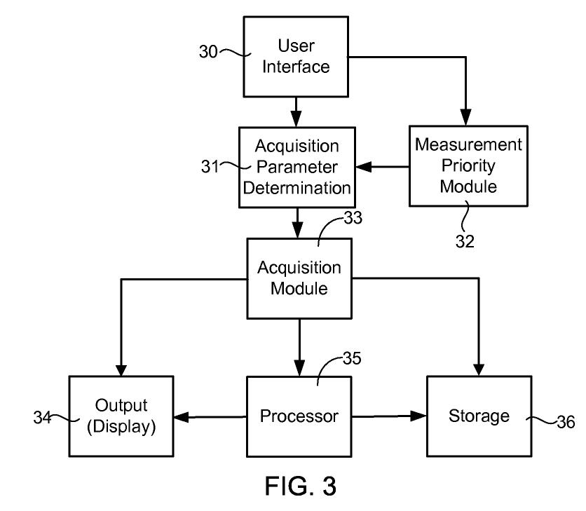

Some embodiments of the present invention may be described with reference to FIG. 3. These embodiments comprise a user interface (UI) 30, like the UIs described in previously-described exemplary embodiments. UI 30 may also receive measurement priority input that may be transmitted to Measurement Priority Module (MPM) 32, where it may be stored as measurement priority data. Measurement priority input and data may comprise information related to the relative priority of measurements including, but not limited to, whether acquisition parameters for one measurement may be adjusted to accommodate another measurement. Measurement priority input may be input in advance of measurement selections or measurement configuration data and stored for later use.

Measurement selection data and measurement configuration data received at the UI 30 may be transmitted to an APDM 31 where the measurement selection data and measurement configuration data may be used to determine acquisition parameters. Measurement priority data may also be received at the APDM 31 from the MPM 32 and used in conjunction with measurement selection data and measurement configuration data to determine acquisition parameters. Once the acquisition parameters are determined, they may be sent to an Acquisition Module (AM) 33 and/or used to configure the AM 33 for data acquisition. The configured AM 33 may then acquire source data and output the data to a measurement process, a display 34, storage 36 or another output device.

In some embodiments, the source data output from the AM 33 may not be suitable for direct measurement, display or storage. In these embodiments, the AM 33 may send the raw source data to a data processor 35 where the source data may be processed to conform to measurement requirements, output or storage constraints or other constraints. In some embodiments, the data processor 35 may perform signal processing tasks such as, but not limited to, filtering, transformation and other processing. When the processing is complete, the processed source data may be sent to measurement processes, an output device 34, such as a display, to a storage device 36 or to some other destination that may be local or remote to the AM 33.

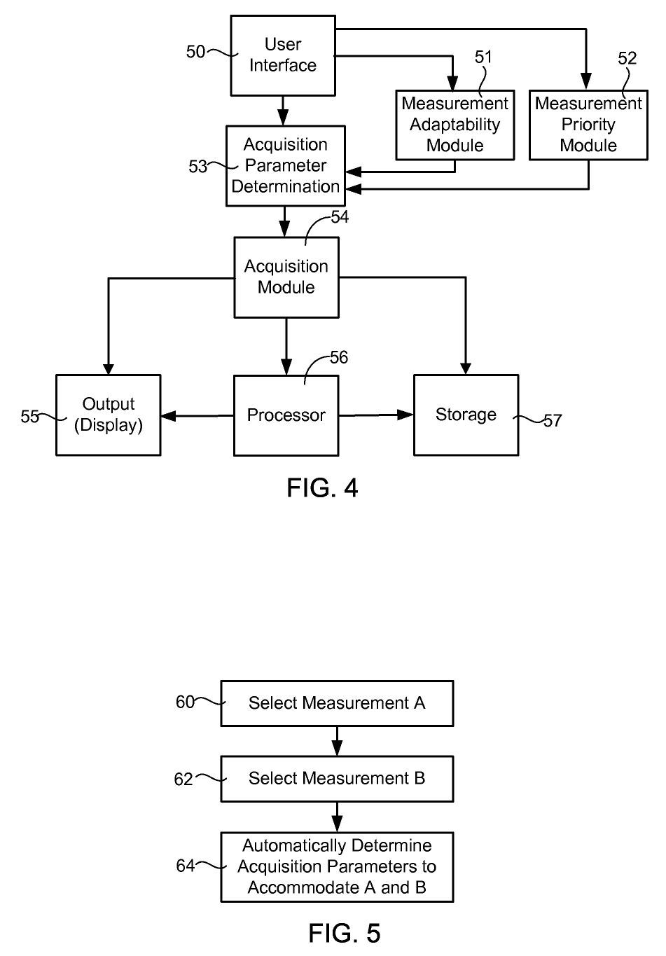

Some embodiments of the present invention may be described with reference to FIG. 4. These embodiments may comprise a user interface (UI) 50, like the UIs described in previously-described exemplary embodiments. These embodiments may also comprise an MAM 51 and an MPM 52. When measurement selections are sent to the APDM 53, acquisition parameters may be selected using input from the UI 50, adaptability data from the MAM 51 and measurement priority data from the MPM 52. Once acquisition parameters are determined, they may be used to configure the acquisition module (AM) 54 and source data may then be obtained with the configured AM 54. Some source data output from the AM 54 may not require processing and may be sent directly to measurement processes, an output device 55 or to a storage device 57.

In some embodiments, the source data output from the AM 54 may not be suitable for direct measurement, display or storage. In these embodiments, the AM 54 may send the raw source data to a data processor 56 where the source data may be processed to conform to measurement requirements, output or storage constraints or other constraints. In some embodiments, the data processor 56 may perform signal processing tasks such as, but not limited to, filtering, transformation and other processing. When the processing is complete, the processed source data may be sent to a measurement process, an output device 55, such as a display, to a storage device 57 or to some other destination that may be local or remote to the AM 54.

Some embodiments of the present invention may be described with reference to FIG. 5, which is a flow chart showing steps of an exemplary method. In these embodiments, a first measurement selection 60, Measurement A, is received, such as at a device UI. A second measurement selection 62, Measurement B, may also be received. These embodiments may then determine 64 acquisition parameters appropriate to configure an AM for acquisition of data appropriate for measurements A and B.

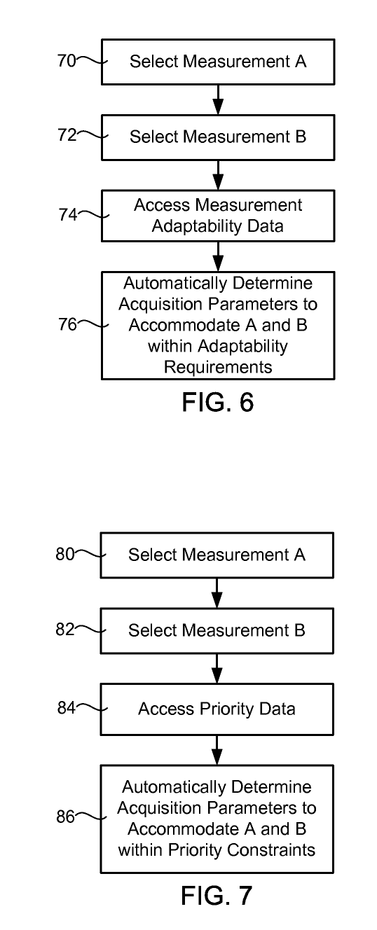

Some embodiments of the present invention may be described with reference to FIG. 6, which is a flow chart showing steps of an exemplary method used by a measurement device. In these embodiments, selection of a first measurement A 70 and a second measurement B 72 are received. Measurement adaptability data 74 may then be accessed to determine 76 whether acquisition parameters can be found that will configure the measurement device to acquire data suitable for both measurements A and B. Using the measurement selections 70 and 72 and the adaptability data 74, acquisition parameters may be automatically determined 76 when the measurements are compatible. In some embodiments, when the measurements 70 and 72 are not compatible, a conflict message may be displayed to a user or the user may be prompted for additional input.

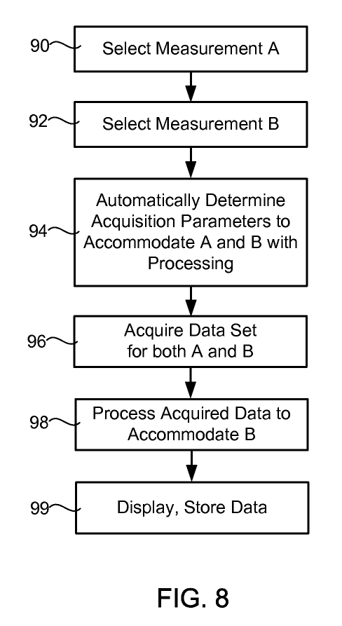

Some embodiments of the present invention may be described with reference to FIG. 7, which is a flow chart showing steps of an exemplary method used by a measurement device. In these embodiments, selection of a first measurement A″ 80 and a second measurement B 82 are received. Measurement priority data 84 may also be received or accessed from a priority module (PM). When one measurement takes priority over another measurement, the parameters for the priority measurement may be favored when ideal acquisition parameters for both measurements cannot be selected. In some cases, the acquisition parameters may be selected such that the accuracy, resolution or some other aspect of the non-priority measurement is less than ideal. In this manner, acquisition parameters may be determined 86 for the measurement instrument.

Some embodiments of the present invention may be described with reference to FIG. 8, which is a flow chart showing steps of an exemplary method used by a measurement device. In these embodiments, selection of a first measurement A 90 and a second measurement B 92 are received. Once measurements have been selected, acquisition parameters may be automatically determined 94. During the determination of acquisition parameters, if one measurement cannot be accommodated adequately without processing the acquired data, the data may be acquired 96 and processed 98 for that measurement before being measured and/or displayed 99.

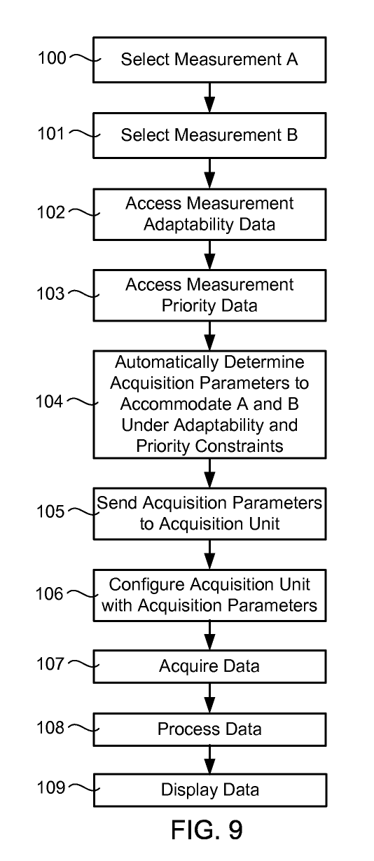

Some embodiments of the present invention may be described with reference to FIG. 9, which is a flow chart showing steps of an exemplary method used by a measurement device. In these embodiments, selection of a first measurement A 100 and a second measurement B 101 are received. Measurement adaptability data may also be accessed 102 to determine the extent to which a measurement selection may be modified or the extent to which acquisition parameters may be adjusted while still producing an acceptable measurement result. Measurement priority data may also be accessed 103 to determine whether one measurement takes priority over another measurement. If one measurement has priority, acquisition parameters for that measurement may be optimized while the acquisition parameters yield non-optimal results for other measurements.

Once the measurements have been selected and adaptability and priority data have been obtained, acquisition parameters may be automatically determined 104. These parameters may then be sent 105 to the acquisition module and the acquisition module may be configured 106 using the parameters. Data may then be acquired 107 for the measurements. When processing is needed to accommodate a measurement, the acquired data may be processed 108. After data acquisition 107 and processing 108, when necessary, the data may be processed and results may be sent to a display 109 for consumption by a user or may be stored for future use.

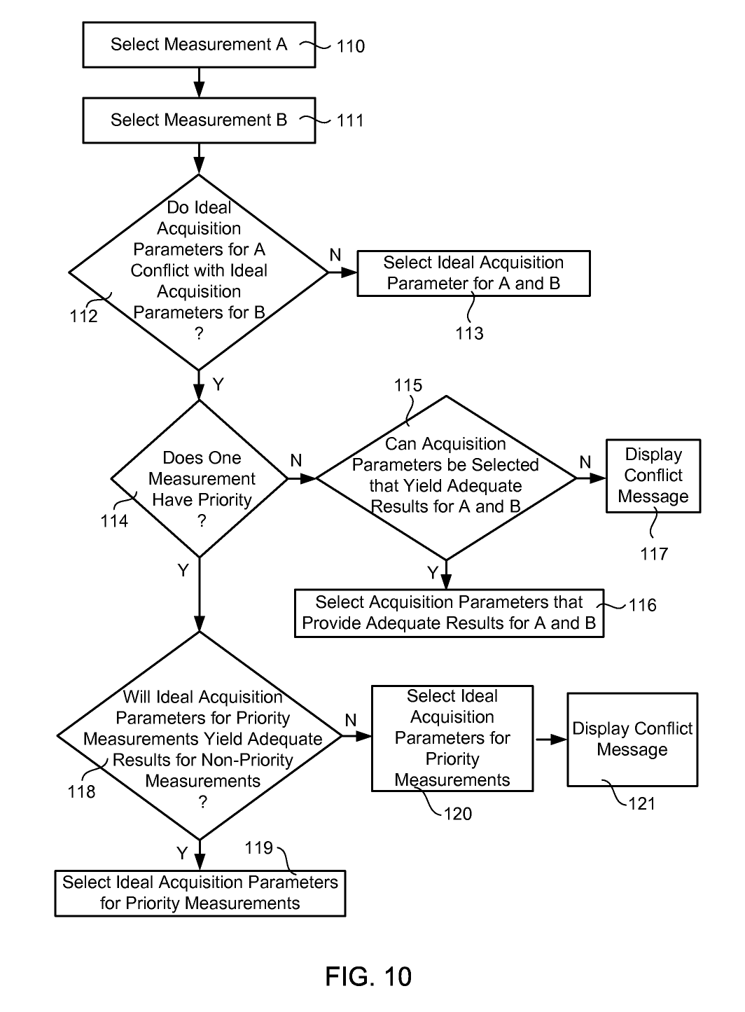

Some embodiments of the present invention may be described with reference to FIG. 10, which is a flow chart showing steps of an exemplary method used by a measurement device. In these embodiments, selection of a first measurement A 110 and a second measurement B 111 are received. These embodiments then determine 112 whether ideal acquisition parameters for measurement A conflict with the ideal acquisition parameters for measurement B. If there is no conflict, the ideal parameters are selected 113 and used to configure the acquisition module. If there is a conflict, measurement priorities may be consulted. If no measurement has priority over the others, measurement adaptability data is consulted to determine 115 whether acquisition parameters can be chosen that will yield acceptable results for measurements A and B. If so, those acquisition parameters are selected 116 and used for configuration of the acquisition module. If acquisition parameters cannot be selected that will yield acceptable results for all measurements, a conflict message may be displayed 117 and further user input may be solicited to resolve the conflict. In some embodiment, a measurement may be automatically omitted when a conflict occurs.

If one measurement does have priority over another, these embodiments may determine 118 whether the ideal parameters for the priority measurement will also result in an acceptable result for the non-priority measurement. If this is possible, the ideal acquisition parameters for the priority measurement are selected 119 and used to configure the acquisition module. If the ideal parameters for the priority measurement do not result in acceptable data for the non-priority measurement, it may be determined 120 whether acquisition parameters may be found that result in acceptable data for both the priority and non-priority measurements. If this cannot be achieved, a conflict message 121 may be displayed to the user and/or further user input may be solicited to resolve the conflict.

The terms and expressions which have been employed in the foregoing specification are used therein as terms of description and not of limitation, and there is no intention in the use of such terms and expressions of excluding equivalence of the features shown and described or portions thereof, it being recognized that the scope of the invention is defined and limited only by the claims which follow.

What is claimed is:

1. An apparatus for determining measurement acquisition parameters, said apparatus comprising:
a) an interface for receiving a first measurement selection and a second measurement selection; and
b) a processor for determining acquisition parameters for an acquisition module, wherein said acquisition parameters may be used to configure said acquisition module to acquire a source data set that accommodates said first measurement and said second measurement.

2. An apparatus as described in claim 1 further comprising said acquisition module.

3. An apparatus as described in claim 1 further comprising a measurement adaptability module.

4. An apparatus as described in claim 1 further comprising a measurement priority module.

5. An apparatus as described in claim 1 wherein at least one of said acquisition parameters is selected from the set consisting of: sampling rate, length of acquisition, acquisition frequency range, reference level, dither settings, number of samples, filtering and correction parameters, input source selection, and signal path gain and attenuation settings.

6. An apparatus as described in claim 1 wherein said interface may also receive measurement adaptability data and wherein said measurement adaptability data may be used as a factor in said determining acquisition parameters.

7. An apparatus as described in claim 1 wherein said interface may also receive measurement priority data and wherein said measurement priority data may be used as a factor in said determining acquisition parameters.

8. An apparatus as described in claim 1 further comprising processing said source data set to accommodate said second measurement.

9. A method for automatically determining measurement device acquisition parameters, said method comprising:
a) receiving a first measurement selection;
b) receiving a second measurement selection;
c) determining acquisition parameters for an acquisition module, wherein said acquisition parameters may be used to configure said acquisition module to acquire a source data set that accommodates said first measurement and said second measurement.

10. A method as described in claim 9 further comprising receiving measurement adaptability data, wherein said measurement adaptability data is used in said determining acquisition parameters.

11. A method as described in claim 9 further comprising receiving measurement priority data, wherein said measurement priority data is used in said determining acquisition parameters.

12. A method as described in claim 9 wherein at least one of said acquisition parameters is selected from the set consisting of: sampling rate, length of acquisition, acquisition frequency range, reference level, dither settings, number of samples, filtering and correction parameters, input source selection, and signal path gain and attenuation settings.

13. A method as described in claim 9 further comprising processing said data set to accommodate said second measurement.

14. An apparatus for determining measurement acquisition parameters, said apparatus comprising:
a) an interface for receiving a first measurement selection and a second measurement selection;
b) adaptability storage for storing measurement adaptability data;
c) an acquisition parameter determination module for determining acquisition parameters for an acquisition module, wherein said acquisition parameters may be used to configure said acquisition module to acquire a source data set that accommodates said first measurement and said second measurement; and
d) a processor for processing said source data set to meet conditions of at least one of said first measurement and said second measurement.

15. An apparatus as described in claim 14 further comprising an acquisition module.

16. An apparatus as described in claim 14 wherein at least one of said acquisition parameters is selected from the set consisting of: sampling rate, length of acquisition, acquisition frequency range, dither settings, number of samples, filtering and correction parameters, input source selection, reference level and signal path gain and attenuation settings.

17. An apparatus as described in claim 14 wherein said interface may also receive measurement adaptability data and wherein said measurement adaptability data may be stored in said adaptability storage and used as a factor in said determining acquisition parameters.

18. An apparatus as described in claim 14 further comprising priority storage for storing measurement priority data, wherein said interface may also receive measurement priority data and wherein said measurement priority data may be stored in said priority storage and used as a factor in said determining acquisition parameters.

19. An apparatus as described in claim 14 wherein said determining acquisition parameters considers the effect of processing acquired source data.

20. An apparatus as described in claim 14 wherein said acquisition parameter determination module outputs a conflict message when acquisition parameters that accommodate said first measurement and said second measurement cannot be determined.

21. An apparatus for accommodating multiple measurements from a single data set, said apparatus comprising:
a) an interface for receiving first measurement configuration data for a first measurement and second measurement configuration data for a second measurement;
b) a receiver for receiving a source data set; and
c) a processor for processing said source data set to accommodate one of said first measurement and said second measurement that is not directly accommodated by said source data set.
